(19) United States
(12) Patent Application Publication
(10) Pub. No.: US 2010/0316861 A1
(43) Pub. Date: Dec. 16, 2010

(54) PLASTICIZER FOR PROTECTIVE FILMS

(75) Inventors: Sandra Kubler, Freiburg (DE); Sabine Eberhardt, Weil am Rhein (DE); Peter Arends, Freiburg i. Br. (DE); Ulrich Siemann, Weil am Rhein (DE)

Correspondence Address: VOLPE AND KOENIG, P.C., UNITED PLAZA, 30 SOUTH 17TH STREET, PHILADELPHIA, PA, 19103, US

(73) Assignee: LOFO High Tech Film GmbH, Weil am Rhein (DE)

(21) Appl. No.: 12/446,026

(22) PCT Filed: Oct. 12, 2007
(86) PCT No.: PCT/EP07/08874

§ 371 Date: Apr. 17, 2009

(30) Foreign Application Priority Data
Oct. 30, 2006 (EP) 06022608.1

(51) Int. Cl. C09D 101/08; B29C 39/00

(52) U.S. Cl. 428/220; 106/170.31; 106/170.33; 106/170.16; 264/299

(57) ABSTRACT

Protective films for plasma displays, spectacles or especially polarizers (for example based on cellulose triacetate) including particular plasticizers as a constituent of imaging devices of liquid-crystal type or of spectacles, their production and use, and liquid-crystal display devices and film polarizers producible with them, and also further subject matter of the invention specified in the description, are particularly suitable for thin films and have advantageous properties, for example low water vapor permeability. The plasticizers used are one or more of the formula (I)

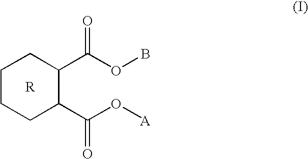

in which the radicals are each as defined in the rest of the disclosure and are branched-chain alkyl radicals having 9 or 10 carbon atoms, and advantageously one or more further plasticizers.

### BACKGROUND

The invention relates to new (cellulose ester, especially triacetyl cellulose (=TAC-based) protective films for screens (displays), especially for polarizers, with defined plasticizers as a component of imaging devices of the liquid-crystal type or of glasses, their production and use, as well as liquid-crystal display devices and film polarizers produced with these films, as well as additional inventive subject matter named below.

Polarizers like those used especially for liquid-crystal display devices, but also for the production of (for example) sunglasses, require protective films that are usually laminated on the (e.g., oriented, fixed, and washed) polarizer on one or usually both sides using adhesive materials. Protective film(s), the actual polarizer (polarizing film), and adhesive layers together form, in the nomenclature used here, a (thus, multi-layer) film polarizer.

As material for the actual polarizers (the layers that change the polarization of light), usually a suitable polymer material is used.

Polarizers are often used that have, as matrices, polymers oriented by stretching on the basis of polyvinyl alcohols and also include iodine and/or dichromatic dyes as actual means for polarizing the light, optionally under cross-linking, e.g., with borates. These polarizers are consequently relatively polar and hydrophilic. Due to the effect of moisture (water), easily disruptive processes and reactions can be generated, for example, with the iodine, that have a negative effect on the structure and the functionality of the polarizers.

Therefore and also for reasons of protection from other, especially mechanical influences, it is necessary to protect the actual polarizers from such disruptive influences through the application of protective films, especially through their adhesion.

Also for plasma displays, such protective films are important components as functional films, for example, with an additional anti-reflection coating.

As protective films, usually cellulose ester films are used, especially with a matrix based on cellulose triacetate (TAC), cellulose triacetate butyrate, cellulose triacetate propionate, and the like. Preferably, cellulose triacetate, advantageously with an acetylization degree (number of acetyl radicals per carbohydrate unit in the cellulose) is measurable in the range of 2.50 to 2.97, especially from 2.90 to 2.96, e.g., according to ASTM-D817-96 (wherein the acetylization degree refers to the state before possible saponification with lyes, such as aqueous NaOH or KOH, for hydrophilization of the surface).

Liquid-crystal displays (e.g., LCD, STN, TSTN, FST, LC, and TFT displays) usually include at least two polarizers above or below the area that encompasses the liquid crystals, (transparent) electrodes, spacers, and (e.g., glass) plates for controlling the orientation and the storage of the liquid-crystal compounds themselves, in addition they can also include optionally one or more compensation films, brightness-amplifying films, prism films, diffuser films, light-guiding plates, reflective layers, and light sources, as well as thin-film transistors (TFT) as components of the actual liquid-crystal cells. Plasma displays also require suitable protective films, on one hand, as protection and, on the other hand, as a base for functional coatings, such as anti-reflection coatings.

There is now an increasing need for very thin film polarizers in order to reduce the total thickness of, for example, liquid-crystal displays, for example, also to save material for large surfaces (for example, for flat screens) or, on the other hand, to achieve suitable minimization especially for small (such as mobile phone or PDA) screens.

Because at least two polarizers are needed for a liquid-crystal display and each of these is usually coated on both sides by a protective film, a reduction of the thickness of the protective films that currently usually lies in the range of approximately 80 μm, would also lead to a significant reduction in the total thickness of the film polarizers and thus in the liquid-crystal displays overall.

There have already been a series of tests that make thinner protective films available. Here it has proven problematic that there is a large number of parameters that often act against each other due to often opposite effects in the variation of components of the protective films and thus lead to the result that suitable thin protective films, for example, with thicknesses in the range from 10 to 60 μm, correspond to the demanded requirement profiles only with much difficulty. These properties include scattering (haze), light transmissivity (transmission), surface hardness, shrinkage properties, mechanical stability, water absorption and water vapor permeability, elasticity, optical delay, adjustability of suitable hydrophilic properties for bonding with the adhesives that must themselves be sufficiently hydrophilic due to the hydrophilic materials (such as PVA) used for the actual polarizer, and many others.

### SUMMARY

The objective of the present invention is therefore to provide protective films, especially for polarizers, but also the mentioned other purposes (lenses for glasses, plasma displays) that have a composition allowing use also with a smaller thickness.

US 2006/0062933 mentions certain compositions for suitable protective films that have, however, in the example part, a thickness of 80 μm. The plasticizers used in the present application are not named there.

### DETAILED DESCRIPTION OF THE PREFERRED EMBODIMENTS

Now it has been shown surprisingly that for rather thin films with 80 μm thickness or below, as noted above, the plasticizers of formula I which were not previously used in the field of polarizer protective films allow especially advantageous properties, especially in mixtures with one or more other plasticizers, in particular, for thinner protective films these guarantee a very advantageous low water vapor permeability and that this takes place independent of the water absorption by the films, wherein the other important properties are not affected or only slightly, in some cases even advantageously.

Compared with low water absorption, low water vapor permeability is possibly the more important parameter, because it permits less entry of water to the (especially in the case of the use of iodine) very moisture-sensitive actual polarizer—while the water absorption does not absolutely have to be associated with a higher negative effect on the actual polarizer through moisture, because this could also mean greater water storage in the protective film (tighter bond with reduced release to the water-sensitive layers) and thus water vapor permeability appears to be the more important parameter.

In other words, the discovered decoupling of the water vapor permeability and the water absorption with certain plasticizers especially for thinner films (below 80 μm thickness) allows the production of thin films without both parameters having to decrease proportionally.

In addition, for the films according to the invention, increased glass transition temperatures can be found compared with those with plasticizers used before, such as, in particular, triphenyl phosphate. An increased glass transition temperature is associated with increased hardness and thus stability of the protective films and is thus desirable.

The protective films according to the invention include, in particular, plasticizers of formula I

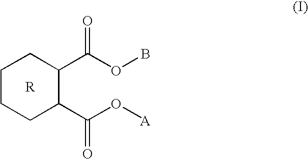

wherein the ring designated with R is a cyclohexane or a benzene ring and A and B each indicate, independently from each other, linear alkyl radicals with 7 to 8 carbon atoms that are substituted by a methyl, ethyl, or n-propyl radical such that A or B are branched hydrocarbon chains with the measure that each of the radicals A and B contain overall 9 or 10 carbon atoms.

Advantageously, a protective film according to the invention contains a plasticizer of formula I in pure form, especially a corresponding cyclohexane-1,2-dicarboxylic acid ester, above all a corresponding diisononyl ester.

In a preferred embodiment of the invention, a protective film according to the invention contains, in addition to at least one plasticizer of formula I, one or more other plasticizers, especially one other plasticizer. Advantageously, the weight percentage of a plasticizer of formula I, with respect to the total amount of all plasticizers, lies at 10 to 90 wt. %, advantageously 20 to 80 wt. %, especially at 33 to 67 wt. % in the protective film.

The total percentage of plasticizers in the protective film, with respect to the weight of the final protective film, advantageously lies in the range from 5 to 15 wt. %, especially in the range from 8 to 13 wt. %, for example, at 10 to 12 wt. %.

As the other plasticizers, typical plasticizers come into consideration, such as, aliphatic dicarboxylic acid ester, e.g., dioctyl adipate, dicyclohexyl adipate, or diphenyl succinate, ester, and/or carbamates of unsaturated or saturated alicyclic or heterocyclic di- or polycarboxylic acids, such as di-2-naphthyl-1,4-cyclohexane dicarboxylate, tricyclohexyl tricarbamate, tetra-3-methylphenyl tetrahydrofurane-2,3,4,5-tetracarboxylate, tetrabutyl-1,2,3,4-cyclopentane tetracarboxylate, triphenyl-1,3,5-cyclohexyl tricarboxylate, triphenyl benzene-1,3,5-tetracarboxylate, phthalic acid-based plasticizers except those of formula I, such as diethyl, dimethoxyethyl, dimethyl, dioctyl, dibutyl, di-2-ethylhexyl or dicyclohexyl phthalate, dicyclohexyl terephthalate, methyl phthalyl methyl glycolate, ethyl phthalyl ethyl glycolate, propyl phthalyl propyl glycolate, butyl phthalyl butyl glycolate, glycerine ester, such as glycerine triacetate, citric acid-based plasticizers, such as acetyl trimethyl citrate, acetyl triethyl citrate, or acetyl butyl citrate, polyether-based plasticizers, or advantageously (due to improved up to, in particular, to synergistic effectiveness with the plasticizers of formula I, but also from reasons of environmental compatibility and good processability, phosphoric acid ester-based plasticizers, such as triphenyl phosphate (very preferred), tricresyl phosphate, biphenyl diphenyl phosphate, butylenes-bis(diethyl phosphate), ethylene-bis(diphenyl phosphate), phenylene-bis(dibutyl phosphate), phenylene-bis(diphenyl phosphate), phenylene-bis(dixylenyl phosphate), bisphenol-A-diphenyl phosphate, diphenyl-(2-ethylhexyl) phosphate, octyl diphenyl phosphate, or triethyl phosphate.

“Include” or “comprise” or “have” mean that, in addition to the listed features and/or components, other features, processing steps, and/or components could also be present, i.e., a non-conclusive list is given. In contrast, “consists” means that in the thusly characterized embodiment, only the named features, processing steps, and/or components are given.

One or more other functional layers, such as hard-coat layers, anti-glare layers, low or anti-reflection layers, anti-stain layers, antistatic layers, conductive layers, optically anisotropic layers, liquid-crystal layers, adhesive layers, or intermediate layers can or will be deposited on a protective film according to the invention, for example, according to a typical method for coating, vapor deposition, sputtering, plasma discharge, flame discharge, and the like.

A protective film according to the invention can include other additives (added, for example, for the production of the solution or the dispersion of the protective film components), such as, dispersion agents, dyes (preferred), fluorescing dyes, phosphorescing dyes, pigments, fillers, inorganic polymers, organic polymers, anti-foaming agents, lubricants, antioxidants (such as obstructed phenols, obstructed amines, phosphorus-based antioxidants, sulfur-based antioxidants, oxygen scavengers or the like, for example, in an amount from 0.1 to 10 wt. % with respect to the final protective film), acid scavengers (e.g., diglycidyl ether of polyglycols, metal epoxy compounds, epoxidized ether condensate products, diglycidyl ether, e.g., from Bisphenol A, epoxidized unsaturated fatty acid esters, epoxidized plant oils, or the like, for example, in an amount from 0.1 to 10 wt. % with respect to the weight of the final protective film), radical scavengers, means for increasing the electrical conductivity, thickeners, anti-bleaching agents, preservatives, chemical stabilizers, such as sterile obstructed amines (such as, 2,2,6,6 tetraalkyl piperidine) or phenols, UV absorbers (such as oxy-benzophenone-based, benzotriazole-based, salicylic acid-based, benzophenone-based, cyanoacrylate-based, nickel complex-based, or triazine-based compounds or the like, e.g., in an amount from 0.1 to 5 wt. % with respect to the final film), IR absorbers, means for adjusting the index of refraction, gas permeability-reduced agents, antimicrobial agents, anti-blocking agents (also designated, in an especially preferred way as matting agents) that allow, for example, good separability of contacting protective films, e.g., metal oxides, such as silicon dioxide, titanium dioxide, aluminum oxide, zirconium oxide, calcium carbonate, kaolin, talcum, calcined calcium silicate, hydrated calcium silicate, aluminum silicate, magnesium silicate or calcium phosphate, small inorganic particles based on phosphoric acid salts, silicic acid salts of carboxylic acid salts, or small cross-linked polymer particles, for example, in an amount from 0.001 to 5 wt. % with respect to the final protective film, other than the already mentioned stabilizers or the like, or mixtures of two or more such additives. Such additives for the purpose of producing protective films for polarizers in liquid crystal displays are familiar to those skilled in the art. The total quantity of all of the other such additives that are used advantageously lies at 0.1 to 25 wt. %.

Another embodiment of the invention relates to a method for the production of protective films of the type according to the invention (as defined above and below or in the claims), wherein the plasticizer or plasticizers of formula I and the other plasticizer or plasticizers are added to the mixture used for the production of the protective films in the scope of a typical method for the production of such protective films.

Advantageously, the components of the mixture that is used (for a foil-casting method in a solvent or solvent mixture) are prepared (in a preparation or advantageously step by step, e.g., under the use of prepared solutions of components (made, for example, with stirring or dispersion), such as the cellulose ester, the plasticizer or plasticizers and optionally one or more additives and their mixture) and then processed into a protective film according to the invention by means of a typical process, advantageously “solution-casting”=film-casting methods on a corresponding film-casting machine under controlled spreading on a suitable base, such as a metal band, and controlled drying, advantageously according to known methods, as described, for example, in US 2005/0045064 A1 that is incorporated here by reference in this respect.

As solvents or solvent mixtures, for example, cyclical or acyclical esters, ketones, or ethers each with 3 to 12 carbon atoms, or suitable halogenated (especially chlorated) solvents come into consideration, such as, in particular, dichloromethane or chloroform, advantageously in a mixture with a linear, branched, or cyclical alcohol, especially methanol, wherein the alcohol can also be fluorated. Advantageously, a mixture is used made from a chlorated hydrocarbon, such as, in particular, methylene chloride, and an alcohol, in particular, methanol. For mixtures of one of the named non-alcoholic and one of the named alcoholic solvents, their volume ratio advantageously lies at 75 to 25 up to 95 to 5, for example, at 90 to 10 (nonalcoholic solvents to alcoholic solvents, v/v).

In order to achieve a good ability to combine with an adhesive for the lamination of polarizer layers (especially on a PVA basis), the resulting protective film is advantageously partially hydrolyzed in another step, in order to increase (at least at the surface) the hydrophilic properties, for example, by means of an aqueous base, such as an alkali metal hydroxide, in particular, KOH or NaOH, at temperatures in the range from 0 to 80° C., e.g., at approximately 50° C., wherein the hydrolysis can last, for example, 0.1 to 10 minutes, in one possible, preferred variant, e.g., 1 to 3 minutes. Following this are one or more washing steps, e.g., with water of suitable purity, and a drying step.

A protective film according to the invention can also be provided with other coatings, as described above, for example, before or after the lamination with the polarizer or also only after the attachment to other components of a liquid crystal display or glasses.

Another embodiment of the invention relates to the use of the plasticizer or plasticizer mixture named in the protective films described above or below (also in the claims) in the production of protective films for lenses for glasses, plasma displays, and advantageously for film polarizers, in particular, for glasses and, above all, for liquid-crystal displays characterized in that one or more (especially designated as preferred), especially one or also two, plasticizers of formula I and optionally one or more other plasticizers as described (especially designated as preferred) for the production of protective films are added these films (advantageously in the amounts and amount ratios designated as preferred), the mixtures of components used for this purpose, also solvents named for the description of the method, and, if desired, other optional additives as described herein, and the protective films are produced from the resulting mixtures. Advantageously, the use of the plasticizer or plasticizers includes a method as described above and in the claims. In particular, the use can take place for the production of film polarizers, in which partial hydrolysis is performed in addition to the processing steps named above, advantageously under the conditions described above, and then lamination is performed on one or two sides of a polarizer.

The invention also relates to a lens for glasses, a plasma display, or advantageously a film polarizer that has one or more, advantageously one or two protective films according to the invention (i.e., those with one or more plasticizers of formula I and if desired at least one other plasticizer, especially in the amount ratios designated as preferred).

The invention also relates to a plasma display, to glasses (e.g., sunglasses), or especially to a liquid-crystal display that has at least one protective film according to the invention (and can optionally have other components named above).

Preferred are protective films according to the invention in which it involves cellulose esters, especially triacetyl cellulose-based protective films, above all, with an acetylization degree from 2.50 to 2.98, especially from 2.90 to 2.96.

Preferred are protective films according to the invention that have a thickness from 10 to 200, advantageously from 20 to 80, in particular from 10 to 75, advantageously from 10 to 80, above all, from 20 to 60, very preferred from 35 to 45 μm.

Greatly preferred are protective films according to the invention, wherein the plasticizers of formula I involve bis(2-propylheptyl)phthalate or 1,2-cyclohexandicarboxylic acid diisononyl ester.

Greatly preferred are also protective films according to the invention that contain, in addition to one or more, advantageously one plasticizer(s) of formula I, one or more, advantageously one other plasticizer, in particular, a phosphoric acid ester-based plasticizer, in particular, triphenyl phosphate.

Very preferred are protective films according to the invention, wherein the ratio therein of the total amount of plasticizer(s) of formula I to the plasticizer or plasticizers lies at 1:4 to 4:1 weight percentages (20 to 80-80 to 20 wt. %), especially at 1:3 to 3:1 (25 to 75-75 to 25 wt. %), advantageously at 1:2 to 2:1 weight percentages (33:67-67 to 33 wt. %) with respect to the plasticizer total weight.

Very preferred are, in particular, protective films according to the invention, wherein the portion of plasticizer(s) in the final protective film, with respect to their weight, lies overall in the range from 5 to 15 wt. %, advantageously from 8 to 13 wt. %, especially from 10 to 12 wt. %.

Very preferred are protective films according to the invention that have one or more other functional layers, especially selected from hard-coat layers, anti-glare layers, anti-reflection layers, anti-stain layers, antistatic layers, conductive layers, optically anisotropic layers, liquid-crystal layers, adhesive layers, and intermediate layers.

Very especially preferred are protective films according to the invention that have a water vapor permeability below that for the use of the same quantity of triphenyl phosphate as the sole plasticizer instead of the plasticizer or plasticizers according to one of claims 1 to 12, advantageously relative to the use of triphenyl phosphate as a plasticizer of water vapor permeability reduced by at least 10%, especially for a thickness of 40 μm, a water vapor permeability of below 175 g/m² per day, advantageously below 165 g/m² per day.

Very especially preferred are also protective films according to the invention that have a glass transition temperature increased by 10° C. or more, advantageously by 13° C. or more relative to an otherwise equivalent film with triphenyl phosphate as the sole plasticizer.

Preferred is also a method for the production of protective films according to the invention, wherein the protective films are produced from a solution of their components in a suitable solvent mixture through drying in a film-casting method.

Advantageously, for a production method according to the invention, the protective films are then partially hydrolyzed for increasing the hydrophilic properties in another step.

The invention relates, in particular, to embodiments of the invention named as examples, and/or to embodiments as named in the claims, which are here incorporated through reference, and also in the abstract, which is similarly incorporated through reference. Where broader feature definitions are used, these can be replaced by definitions disclosed more narrowly (individually or in several parts) in the scope of the present disclosure, which leads to preferred embodiments of the invention.

### EXAMPLES

The following examples are used for illustrating the invention without limiting their scope:

In the tests listed below, the example number is always pointed out with curly braces { }, {REF} indicates a reference example.

Test 1: TAC Films with Different Plasticizers

TAC films with a thickness of 40 μm are produced with different plasticizers from the following table:

TABLE 1
Plasticizer

| Tradename* | Company | Chemical Designation | CAS No. |
|---|---|---|---|
| TPP | Lanxess | Triphenyl phosphate | 115-86-6 |
| EPEG | ABCR | Ethyl phthaleyl glycolate | 84-72-0 |
| | GmbH & | | |
| | Co. | | |
| Diplast L 7-9 | Lonza | 1,2-benzenedicarboxylic acid | 68515-41-3 |
| | | di-C₇-C₉ alkylester, branched | |
| | | and linear | |
| Diplast L11 | Lonza | Diundecyl phthalate | 3648-20-2 |
| Diplast | Lonza | | Trimellitate |
| TM8-10 | | | with linear |
| | | | C₈-C₁₀ |
| | | | alcohols |
| TMTM | LONZA | Trimethylbenzene-1,2,4- | 2459-10-1 |
| | | tricarboxylate | |
| Palamoll | BASF | Adipine acid polymer with 2,2- | 208945-13-5 |
| 652 | | dimethyl-1,3 propandiol and 1,2 | |
| | | propandiol, isononylester | |
| Palatinol N | BASF | Diisononyl phthalate | 28553-12-0 |
| Palatinol | BASF | Bis(2-propylheptyl)phthalate | 53306-54-0 |
| 10-P | | | |
| Hexamoll | BASF | 1,2-cyclohexandicarboxylic acid | 166412-78-8 |
| DINCH | | diisononyl ester | |
| Crodamol | Croda | Mixture of fatty acid esters | Mixture |
| HCS-50 | | | |
| Triacentine | Lanxess | Glycerin triacetate | 102-76-1 |
| Adimol DO | Lanxess | Dioctyl adipate | 103-23-1 |
| Disflamoll | Lanxess | Diphenyl-(2-ethylhexyl) | 1241-94-7 |
| | | phosphate | |
| DPO | | | |

*also used below as designation

The production is performed under the use of a varnish made from 16 wt. % cellulose triacetate (contents of bound acetyl 60.8%) in methylene chloride/methanol (90/10 v/v) without plasticizers that is filtrated by Calmuc (cotton fabric). Then it is stored overnight in the shutter cabinet (here dyes can be added if desired). If anti-blocking agents (silicon dioxide) is added (if mentioned in the following example), this happens by additive solutions in methylene chloride/methanol 90/10 v/v with 8% cellulose triacetate. The varnish is then portioned and each TPP is added in a portion of 12 wt. % or TPP in a portion of 7 wt. % and each of the other plasticizers in a portion of 5 wt. %, as well as additional methylene chloride/methanol (90/10), in order to again obtain 16% varnish, and moved for dissolving overnight in the shutter cabinet. These varnishes are deaerated in the water bath and each spread out using a doctor blade (casting gap 325 μm, rolling rate 25 mm/sec) Coatmaster® 509 MC from Erichsen GmbH & Co. KG, Hemer, Germany) hand casts on a 10 mm glass plate and dried overnight at 80° C. and thus 40 μm thick films are produced. With these hand casts (films), haze and transmission are measured directly after the drying:

Specification for Measuring Haze and Transmission:

a) Haze: for the measurement, a light image strikes a sample and is incident in an integrated sphere. The light distributed uniformly by the matte-white coating of the spherical wall is measured in a detector. The total transmission is determined with a closed sphere and the haze is determined with an open sphere output. A ring sensor in the outlet opening measures the image sharpness. In actuality, the measurement takes place with a Gardener BYK Haze-Guard plus 4725 device (Byk-Gardner GmbH, Geretsried, Germany). The sample is illuminated vertically and the transmitted light is measured photoelectrically in the integrated sphere (0°/diffuse geometry). The spectral sensitivity is adapted to the CIE standard spectral value function y under standard light C. The measurement device corresponds to the standards ASTM D-1003 (Standard test methods for haze and light transmissivity of transparent plastics) and ASTM-D 1044 (Standard test methods for the resistance of plastics relative to surface abrasion).

The determined haze values for hand casts with the mentioned plasticizers all lie below 0.2%, the transmissions in the range from 95 to 96%. They do not differ significantly.

The hand casts are then prepared for tests for shrinkage, water absorption, and weight loss 24 h at 23° C. at 50% relative air humidity.

For determining the shrinkage at 105° C., samples of 10×10 cm diameter are subjected to doubled conditions. The elongation in the transverse (TD) and machine direction (MD) is measured, then stored 120 h at 105° C. in the drying cabinet, then conditioned for 24 h at 23° C. and 50% relative air humidity in the air-conditioning cabinet and the elongation in TD and MD are measured again. The elongation is determined with the help of a measuring disk with an accuracy of 0.05 mm.

The water absorption is performed on samples of 8×8 cm as doubled conditions after drying for 3 days at 50° C. and then conditioning for 24 h at 23° C. and 50% relative humidity in the air-conditioning cabinet. The percentage weight increase of the dried film after conditioning is determined on an analysis scale with an accuracy of ±0.1 mg.

The weight loss is measured using probes of 10×10 cm as doubled conditions after conditioning for 24 h at 23° C. and 50% relative air humidity in a measurement slip on an analysis scale with an accuracy of ±0.1 mg.

The following table shows the water absorption, the shrinkage TD, the shrinkage MD, and the weight loss, as were obtained from the above measurements:

TABLE 2
Water absorption and other parameters

| | Water | Shrinkage | Shrinkage | Weight loss |
|---|---|---|---|---|
| Plasticizer 7% | absorption | TD | MD | (conditioned) |
| TPP plus | [%] | [%] | [%] | [%] |
| 5% TPP {REF} | 0.36 | 1.07 | 1.20 | 1.67 |
| 5% EPEG | 0.28 | 1.37 | 1.37 | 2.36 |
| {REF} | | | | |
| 5% Diplast L | 0.30 | 1.28 | 1.30 | 2.85 |
| 7-9 {REF} | | | | |
| 5% Diplast | 0.45 | 1.03 | 0.85 | 1.94 |
| L11 {REF} | | | | |
| 5% Diplast | 0.26 | 1.13 | 1.07 | 1.40 |
| TM8-10 {REF} | | | | |
| 5% TMTM | 0.34 | 1.13 | 1.05 | 2.45 |
| {REF} | | | | |
| 5% Palamoll | 0.40 | 1.15 | 1.07 | 2.67 |
| 652 {REF} | | | | |
| 5% Palatinol N | 0.28 | 1.28 | 1.15 | 2.62 |
| {Exp. 1} | | | | |
| 5% Palatinol | 0.26 | 1.08 | 1.27 | 2.41 |
| 10-P {Exp. 2} | | | | |
| 5% Hexamoll | 0.32 | 1.10 | 1.10 | 2.45 |
| DINCH {Exp. | | | | |
| 3} | | | | |
| 5% Crodamol | 0.13 | 1.50 | 1.55 | 3.81 |
| HCS-50 {REF} | | | | |
| 5% Triacetin | 0.21 | 1.67 | 1.60 | 4.41 |
| {REF} | | | | |
| 5% Adimoll | 0.33 | 1.35 | 1.33 | 3.35 |
| DO {REF} | | | | |
| 5% Disflamoll | 0.31 | 1.32 | 1.22 | 2.39 |
| DPO {REF} | | | | |

If one allows a tolerance in the averages and values the samples that contain these averages with 0, then 4 plasticizers (marked in the table in bold) in combination with TPP in at least 2 of the 4 measurement parameters are better and 5 in at least 3 of 4 measurement parameters are equal to or better (underlined) than 12% TPP in hand casting, see Table 3:

TABLE 3
comparison overview

| | Water | | | |
|---|---|---|---|---|
| | absorption | Weight | Shrinkage | Shrinkage |
| | 24 h 23° C. | loss | TD | MD |
| Plasticizer | 50% rel. | 5 days 105° C. | | |
| 12% TPP | used as comparison | | | |
| {REF} | | | | |
| EPEG* | + | − | − | − |
| Diplast L 7-9* | + | − | − | 0 |
| {REF} | | | | |
| Diplast L11* | 0 | − | + | + |
| {REF} | | | | |
| Diplast TM8- | + | + | 0 | + |
| 10* {REF} | | | | |
| TMTM* {REF} | + | − | 0 | + |
| Palamoll 652* | 0 | − | 0 | + |
| {REF} | | | | |
| Palatinol N* | + | − | − | + |
| {Exp. 4} | | | | |
| Palatinol 10- | + | − | 0 | 0 |
| P* {Exp. 5} | | | | |
| Hexamoll | + | − | 0 | + |
| DINCH* {Exp. | | | | |
| 6} | | | | |
| Crodamol | + | − | − | − |
| HCS-50* | | | | |
| {REF} | | | | |
| Triacetin* | + | − | − | − |
| {REF} | | | | |
| Adimoll DO* | + | − | − | 0 |
| {REF} | | | | |
| Disflamoll | + | − | − | 0 |
| DPO* {REF} | | | | |
| Allowed | +0.1 | +0.15 | +0.13 | +0.13 |
| deviation | | | | |

*= each 7% of the specified plasticizer +5% TPP

Thus, mixtures of TPP with Diplast L11 (but this exhibits a relatively high water absorption), TMTM (but this exhibits an evaporation rate that is too high), Diplast TM8-10 (but in later tests this exhibited water vapor permeability that was too high), Palatinol N, and Hexamoll DINCH exhibit superior or at least similar properties with respect to the named parameters.

Test 2: Evaporation of the Plasticizer from a 40 μm Film with a Total 12 wt. % Plasticizer at 105° C.:

From 40 μm films dried overnight and produced analogous to Test 1, two 10×10 cm large samples are cut, conditioned for 5.5 h at 23° C. and 50% relative (rel.) air humidity in the climatic cabinet, stored for 113 h at 105° C., and then conditioned again for 3 h. The thickness, the residual solvent contents (RLM per GC measurement), the haze, and the transmission (like under Test 1) and the weight loss are measured.

The thickness is here measured through measurement by a thickness sampler with a plan ground and a spherical measurement surface in connection with DIN 53379, wherein, before the measurement, the sample body is tested for impurities (such as dust), care is to be taken that no curvature causes a measurement error and the upper measurement surface is mounted free from jerks. Before and after each measurement, the zero point of the measurement device is inspected. Measurement points have a spacing of 4-5 cm. The thickness of the sample body is specified as an arithmetic average of 5 individual measurements for each sample. The measurement of the RLM is performed through “headspace gas chromatography) by means of a Perkin Elmer GC system Autosystem XL (Perkin Elmer, Inc., Wellesley, Mass., USA) with TurboMatrix 40 Headspace Sampler (Perkin Elmer) and polymethyl disiloxane OV-1 columns. Nitrogen is used as the carrier gas (40 kPa pressure and split flow mode). At the needle, the temperature is at 150° C., for the transmission at 180° C., in the furnace at 150° C. The cycle time equals 20 min, the heat treatment of the headspace is performed for 120 min at 150° C. Of the film, 40 to 50 mg is weighed.

TABLE 4
Evaporation of the plasticizer

| | | | | | Weight loss |
|---|---|---|---|---|---|
| | | | | | (average |
| | Thickness | RLM | Haze | Transmission | value, n = |
| Plasticizer | (μm) | [%] | [%] | [%] | 2) [%] |
| 12% TPP | 48 | 0.05 | 0.2 | 95.7 | 1.93 |
| {REF} | | | | | |
| 7% TPP + | 42 | 0.01 | 0.28 | 95.9 | 1.83 |
| 5% Diplast | | | | | |
| L11 {REF} | | | | | |
| 7% TPP + | 43 | 0.02 | 0.25 | 95.8 | 3.47 |
| 5% TMTN | | | | | |
| {REF} | | | | | |
| 7% TPP + | 41 | 0.05 | 0.29 | 95.8 | 3.04 |
| 5% | | | | | |
| Palatinol N | | | | | |
| {Exp. 7} | | | | | |
| 7% TPP + | 45 | 0.04 | 0.24 | 95.9 | 1.98 |
| 5% | | | | | |
| Palatinol | | | | | |
| 10P {Exp. | | | | | |
| 8} | | | | | |
| 7% TPP + | 42 | 0.01 | 0.25 | 95.9 | 2.25 |
| 5% | | | | | |
| Hexamoll | | | | | |
| DINCH | | | | | |
| {Exp. 9} | | | | | |

Here it is shown clearly that the TMTM falls from the series, the Palatinol N also exhibits a higher loss value, while the other plasticizers evaporate more slowly or just as quickly as TPP.

Test 3: Water Vapor Permeability

Water vapor permeability is determined as follows:

The films are adhered on metal cans with hot adhesive at the edge on the side of the opening of the cans and the weight loss (evaporated water) is measured for certain relationships.

The measurement is performed in accordance with DIN EN ISO 7783-1, in that the circular sample bodies (diameter 90 mm) prepared from films are mounted on aluminum shells and sealed by hot adhesive. The temperature equals 23±2° C., the relative air humidity outside the shell 50±5%, within the shell 93% (generated by a saturated solution of ammonium dihydrogen phosphate). The water vapor diffusion flow density is calculated after 192 h.

The films are produced analogous to Test 1 (thickness 40 μm). The following results are found:

TABLE 5
Water vapor transmissivity values

| | Water vapor |
|---|---|
| | transmissivity |
| Plasticizer | [g/(m² d)] |
| 12% TPP {REF} | 218 |
| 7% TPP + 5% Diplast L11 {REF} | 171 |
| 7% TPP + 5% Diplast TM8-10 {REF} | 199 |
| 7% TPP + 5% TMTM {REF} | 157 |
| 7% TPP + 5% Palatinol N {Exp. 10} | 158 |
| 7% TPP + 5% Palatinol 10-P {Exp. 11} | 160 |
| 7% TPP + 5% Hexamoll DINCH | 157 |
| {Exp. 12} | |

Thus it has been shown that especially for pure phthalic acid diesters with 9 or 10 carbon atoms in the chain, very good (low) water vapor permeability values are found and every especially for cyclohexan-1,2 dicarboxylic acid ester Hexamoll DINCH.

Test 4: Comparison of Water Vapor Permeability for Different Combinations

The water vapor permeability for films produced like in Test 1 with 40 μm thickness for different combination relationships of the plasticizer is examined.

For this purpose, 40 μm hand casts are produced as described above in Example 1, but under the use of the weight percentages of the plasticizer indicated in the following table.

This time, instead of metal cans, screw ring glasses with 0.5 l volume and two seals are used. The film samples to be measured (previously conditioned for ca. 5 h in the climatic cabinet and cut with circular blades) are each placed between the two seals and fixed by the screw ring on the glass. In the glass, a rel. humidity of 93% is set by 100 ml cold saturated ammonium dihydrogen phosphate solution and 1 g ammonium dihydrogen phosphate. Outside of the glass, the rel. humidity in the climatic cabinet is set at 50% at 23° C. The weight loss is measured by a scale (rounded to 0.01 g) and stored for at least 24 hours for the first value under the named conditions, then the water vapor diffusion flow density is calculated.

Because the water vapor transmissivity depends on the thickness of the hand casts, correction is performed with respect to the thickness with a correlated curve with 10% TPP.

TABLE 6
Comparison of different combination relationships

| | Water vapor |
|---|---|
| | permeability |
| | (corrected with |
| | respect to |
| | film thickness) |
| Plasticizer combination | [g/(m² d)] |
| 12% Hexamoll DINCH {REF} | 175.9 |
| 4% TPP/8% Hexamoll DINCH {Exp. 13} | 163.1 |
| 8% TPP/4% Hexamoll DINCH {Exp. 14} | 161.0 |
| 12% Palatinol 10-P {Exp. 15} | 171.4 |
| 4% TPP/8% Palatinol 10-P {Exp. 16} | 166.6 |
| 8% TPP/4% Palatinol 10-P {Exp. 17} | 158.8 |
| 4% TPP/4% Palatinol 10-P/4% Hexamoll | 163.6 |
| DINCH {Exp. 18} | |
| 4% Hexamoll DINCH/8% Palatinol 10-P | 179.4 |
| {Exp. 19} | |
| 8% Hexamoll DINCH/4% Palatinol 10 P | 166.2 |
| {Exp. 20} | |

From these results it follows that, in particular, mixtures of Palatinol 10-P or Hexamoll DINCH each exhibit with TPP good (low) water vapor permeability values.

Test 5: Determination of Glass Transition Temperature

As described in Test 1, films with anti-blocking agents (solvent as described in Example 1, prefiltered by means of 20 μm Hydac Multilayer (Hydac International GmbH, Sulzbach, Germany) and the glass transition temperature for different plasticizers is determined as follows: the heat of reaction effects are measured with a heat flow difference calorimeter NETZSCH-DSC 204 F1 Phoenix® (Netzsch Gerätebau GmbH, Selb, Germany) with liquid nitrogen cooling that permits tests in a temperature range between −185 and +700° C. Sample preparation and measurement conditions: temperature program 1st+2nd heating 0° C. . . . 220° C., cooling: 220° C. . . . 0° C., heating/cooling rate 20 K/min, atmosphere nitrogen (40 ml/min), crucible: aluminum with perforated lid, sample masses: ca. 7-8 mg.

TABLE 7
Glass transition temperatures

| | Glass transition |
|---|---|
| Plasticizer | temperature [° C.] |
| 10% TPP {REF} | 141.3 |
| 6% TPP/6% Hexamoll DINCH {Exp. 21} | 155.5 |
| 4% TPP/8% Palatinol 10-P {Exp. 22} | 160.6 |

Here, significantly increased values for the glass transition temperature are shown for mixtures of Hexamoll DINCH or Palatinol 10-P with TPP compared with TPP alone. An increased glass transition temperature is associated with increased hardness and thus stability of the protective films and is thus desirable.

From all of the preceding tests (examples and reference examples) taken together it can be inferred that with the compounds of formula I, especially in mixture with phosphoric acid ester plasticizers, such as, above all, TPP, especially also for thin films, good (low) water vapor permeability values are found, wherein other parameters as named in the tests and also, haze and transmission after saponification in 1.5 M NaOH at 50° C., the contact angle (measured as the diameter of 10 μl water droplets), mechanical properties such as fracture resistance, fraction expansion, and elastic modulus, retardation R0 and Rth, hardness and storage resistance, remain largely unaffected or are even better than in the reference examples.

### Example 23

### Production of a Cast Film from Cellulose Triacetate with a Thickness of 40 μm at the Industrial Scale

From 2000 kg cellulose triacetate (acetylization degree 2.96), 11330 kg dichloromethane:methanol mixtures (9:1 v/v), 136 kg TPP, 136 kg Hexamoll DINCH®, 30 kg UV absorber (benzophenon-6) produces a homogenous solution under stirring, cooling and heating cycles, and this is heated to ca. 40° C. for outgassing. By means of buffer tanks, the solution is filtered through several filters made from metal non-woven fabric (pore size 5-7 μm) at elevated pressure and temperature, and then mixed directly (in-line) with a similarly filtered dosed solution that contains, in addition to the substances named above, also another dichloromethane:methanol mixture (9:1 v/v) and an anti-blocking additive.

After heat treatment to 31° C., the solution is cast under a dichloromethane atmosphere with a dichloromethane vapor content of ca. 3 to 15 vol. % and a temperature of 35° C. in the required thickness (cast gap ca. 235 μm) on an endless steel band of 60 m length and ca. 1.5 m width rotating at 18 m/min. The air containing dichloromethane methanol is fed in the region of the cast gap so that a linear gas rate results in the band direction.

The temperature in the band channel is increased at the pick-up point step by step to ca. 85° C. and the formed film is drawn off. This is then fed via a length of 23 m into a clip chain, there dried at a temperature from 60 to 120° C. Then the film is dried over a length of ca. 360 m at 80° C. to ca. 140° C. temperature and finally cut and wound after cooling to 1335 mm width.

After setting a stationary operating state, a film with a solvent residual content of ca. 0.1-0.8 wt. % and an optical delay of ca. 0.5-2.5 nm is obtained.

### Example 24

### Glass Transition Temperatures

Films produced under production conditions analogous to Example 23 have increased glass transition temperatures relative to those with only triphenyl phosphate as plasticizer:

TABLE 8
Glass transition temperatures

| Formulation with plasticizer according | | Formulation with | |
|---|---|---|---|
| to the invention Glass transition | | TPP as sole plasticizer | |
| temperature | | Glass transition temperature | |
| 40 μm film | 80 μm film | 40 μm film | 80 μm film |
| thickness | thickness | thickness | thickness |
| 155° C. | 151° C. | 136° C. | 136° C. |
| (total 8.5% | (total 12% | (10% TPP) | (10% TPP) |
| plasticizer, of this | plasticizer, of this | | |
| 50% TPP, 50% | 50% TPP, 50% | | |
| Hexamoll DINCH) | Hexamoll DINCH) | | |

The water vapor permeability of the films lies at least 10% lower than those of otherwise corresponding films in which only TPP alone is used as the plasticizer.

1. Protective film(s) for lenses of glasses, plasma displays, or especially polarizers with plasticizers as a component of imaging devices of liquid-crystal type or of glasses, the protective film(s) comprises at least one plasticizer of the formula I 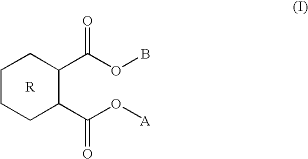
wherein the ring designated with R is a cyclohexane or a benzene ring and A and B each are linear alkyl radicals with 7 to 8 carbon atoms independent of each other that are substituted by a methyl, ethyl, or n-propyl radical such that A or B are branched hydrocarbon chains with the requirement that each of the radicals A and B each has a total of 9 or 10 carbon atoms.

2. Protective film(s) according to claim 1, wherein the protective film(s) comprise cellulose ester.

3. Protective film(s) according to claim 2, wherein the protective film(s) comprise triacetyl cellulose-based protective films with an acetylization degree from 2.50 to 2.98.

4. Protective film(s) according to claim 1, wherein the protective film(s) a thickness from 10 to 200 μm.

5. Protective film(s) according to claim 1, wherein the plasticizers of formula I comprise Bis(2-propylheptyl)phthalate or 1,2-cyclohexane dicarboxylic acid diisononyl ester.

6. Protective film(s) according to claim 1, wherein the protective film or films comprise, in addition to one or more, plasticizer(s) of formula I, one or more additional plasticizer(s).

7. Protective film(s) according to claim 6, wherein the protective film(s) comprise as an additional plasticizer a phosphoric acid ester-based plasticizer.

8. Protective film(s) according to claim 6, wherein a ratio therein of a total amount of plasticizer(s) of formula I to the additional plasticizer(s) at 1:4 to 4:1 weight percentages (20 to 80-80 to 20 wt. %), with respect to a plasticizer total weight.

9. Protective film(s) according to claim 8, wherein the percentage of plasticizer(s) in the final protective film with respect to its weight lies overall in the range from 5 to 15 wt. %.

10. Protective film(s) according to claim 1, further comprising one or more additional additives selected from dispersion agents, dyes, fluorescing dyes, phosphorescing dyes, pigments, fillers, inorganic polymers, organic polymers, anti-foaming agents, lubricants, antioxidants, acid scavengers, radical scavengers, agents for increasing electrical conductivity, thickening agents, anti-bleaching agents, preservatives, chemical stabilizers, UV absorbers, IR absorbers, agents for adjusting the index of refraction, gas permeability-reducing agents, antimicrobial agents, anti-blocking agents, and other than already named stabilizers that are advantageously present overall in a weight percentage with respect to the weight of the final protective film(s) from 0.1 to 25 wt. %.

11. Protective film(s) according to claim 1, further comprising one or more additional functional layers, selected from hard-coat layers, anti-glare layers, anti-reflection layers, anti-stain layers, antistatic layers, conductive layers, optically anisotropic layers, liquid-crystal layers, adhesive layers, and buffer layers.

12. Protective film(s) according to claim 1, wherein the protective film(s) have a water vapor permeability below that from the use of a same amount of triphenyl phosphate as the sole plasticizer instead of the plasticizer or plasticizers according to claim 1, a water vapor permeability reduced by at least 10% relative to the use of triphenyl phosphate as the plasticizer, and a water vapor permeability of below 175 g/m² per day.

13. Protective film(s) according to claim 1, wherein the protective film(s) have a glass transition temperature increased by 10° C. or more, relative to an otherwise equivalent film with triphenyl phosphate as the sole plasticizer.

14. Method for the production of protective films comprising at least one plasticizer of 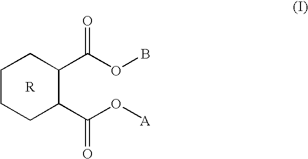
the formula I
wherein the ring designated with R is a cyclohexane or a benzene ring and A and B each are linear alkyl radicals with 7 to 8 carbon atoms independent of each other that are substituted by a methyl, ethyl, or n-propyl radical such that A or B are branched hydrocarbon chains with the requirement that each of the radicals A and B each has a total of 9 or 10 carbon atoms, and the plasticizer or plasticizers of formula I and additional plasticizer or plasticizers are added to a mixture used for the production of the protective films.

15. Method according to claim 14, wherein the protective films are produced from a solution of its components in a suitable solvent mixture through drying in a film casting method.

16. Method according to claim 15, wherein the protective film is then partially hydrolyzed for increasing hydrophilic properties in another step.

17.-20. (canceled)
